(19) United States
(12) Patent Application Publication
(10) Pub. No.: US 2012/0093601 A1
(43) Pub. Date: Apr. 19, 2012

(54) MACHINE TOOL WITH PROTECTIVE FENCE

(76) Inventor: Katsumi Hirabayashi, Tagata-Gun (JP)

(21) Appl. No.: 13/263,279

(22) PCT Filed: Apr. 7, 2010
(86) PCT No.: PCT/JP2010/056317

§ 371 Date: Dec. 22, 2011

(30) Foreign Application Priority Data
Apr. 7, 2009 (JP) 2009-092858

(51) Int. Cl. B23Q 11/00; B23B 47/00

(52) U.S. Cl. 408/234; 409/134

(57) ABSTRACT

The present invention relates to a machine tool in which a column including a main spindle with a working tool mounted thereon is movable in a direction along an edge part of a machine platen, wherein a protective fence is provided on the edge part of the machine platen.

### FIELD OF THE INVENTION

The present invention relates to a machine tool provided with a protective fence. More particularly, the present invention relates to a large-size machine tool provided with a protective fence, in which a column including a main spindle with a working tool mounted thereon is moved along a machine platen.

### BACKGROUND ART

In a machine tool, safety measures for an operator who operates the machine tool have been conventionally taken. For example, a safety device, in which a protective fence door is equipped with a locking mechanism and an interlocking device for detecting opening and closing of the door, is known by JP2001-336694A.

When a large-size machine tool is used, an operator should sometimes enter the machine tool and come close to an object to be processed (work). In this case, a further safety implement is requested in addition to the interlocking mechanism of the protective fence door or the like.

For example, there is supposed a relatively large-size machine tool in which a column including a main spindle with a working tool mounted thereon is moved along a machine platen. To be specific, a conventional floor-type horizontal boring machine (a floor-type machine tool for horizontal milling and boring) is described, for example. As shown in FIG. 8, in a floor-type horizontal boring machine 100 of this type, a deep groove 102 is disposed adjacently to a machine platen 101 on which a work is placed (the groove 102 extends in a direction perpendicular to the sheet surface of FIG. 8). By moving a column 104 including a main spindle 103 with a working tool mounted thereon in the groove 102 in a direction of the groove 102 (by moving the column 104 in the direction perpendicular to the sheet surface of FIG. 8), the work placed on the machine platen 101 is processed.

In the conventional floor-type horizontal boring machine 100, there is a possibility that an operator on the machine platen 101 might fall down into a space depicted by the reference character A of the groove 102 for some reason or other. Namely, it cannot be necessarily said that a safety of the operator on the machine platen 101 (operator who has entered the machine tool 100) is sufficiently ensured. Thus, it is necessary to call the operator's attention for ensuring his/her safety.

### SUMMARY OF THE INVENTION

In view of the above circumstances, the present invention has been made to effectively solve the same. The object of the present invention is to provide a machine tool in which a column including a main spindle with a working tool mounted thereon is movable along a machine platen, the machine tool being capable of ensuring a safety of an operator who is on the machine platen in the machine tool.

The present invention is a machine tool in which a column including a main spindle with a working tool mounted thereon is movable in a direction along an edge part of a machine platen, wherein a protective fence is provided on the edge part of the machine platen.

According to the present invention, a safety of an operator on the machine platen in the machine tool can be ensured, by means of the protective fence provided on the edge part of the machine platen, against the column including the main spindle with the working tool mounted thereon. For example, when the column including the main spindle with the working tool mounted thereon is movable within a groove along the edge part of the machine platen, the risk of the operator on the machine platen falling down into the groove can be significantly reduced.

Preferably, the protective fence includes: one-side protective fence disposed on the column, on one side of the moving direction of the column; and the other-side protective fence disposed on the column, on the other side of the moving direction of the column. In this case, more preferably, when the column is moved toward the one side of the moving direction, the one-side protective fence is configured to be contracted in the moving direction, and when the column is moved toward the other side of the moving direction, the one-side protective fence is configured to be extended in the moving direction, and when the column is moved toward the one side of the moving direction, the other-side protective fence is configured to be extended in the moving direction, and when the column is moved toward the other side of the moving direction, the other-side protective fence is configured to be contracted in the moving direction. When such a structure is employed, since an area protected by the protective fence is moved in accordance with the movement of the column, the safety of the operator on the machine platen can be more reliably ensured.

In brief, it is preferable that the protective fence is configured to be moved or deformed in accordance with the movement of the column. When the area protected by the protective fence is suitably set in accordance with the movement of the column, the safety of the operator on the machine platen can be more reliably ensured.

In this case, it is preferable that the protective fence is configured to be moved or deformed by a driving device for moving the column, in conjunction with the movement of the column. Alternatively, it is preferable that the protective fence is configured to be moved or deformed by another driving device that is different from the driving device for moving the column.

For example, the machine tool is a floor-type boring machine.

### BRIEF DESCRIPTION OF THE DRAWINGS

FIG. 1 is a schematic view of a floor-type horizontal boring machine (floor-type machine tool for horizontal milling and boring) in one embodiment of the present invention;

FIG. 2 is a sectional view in the B-B direction in FIG. 1;

FIG. 3 is a sectional view in the C-C direction in FIG. 2;

FIG. 4 is a view showing an example of a dedicated driving device for moving a protective fence;

FIG. 5 is view showing a protective fence in another embodiment of the present invention;

FIG. 6 is a sectional view in the D-D direction in FIG. 5.

FIG. 7 is a view showing a protective fence in still another embodiment of the present invention; and

FIG. 8 is a schematic view of a conventional floor-type horizontal boring machine (floor-type machine tool for horizontal milling and boring).

### BEST MODE FOR CARRYING OUT THE INVENTION

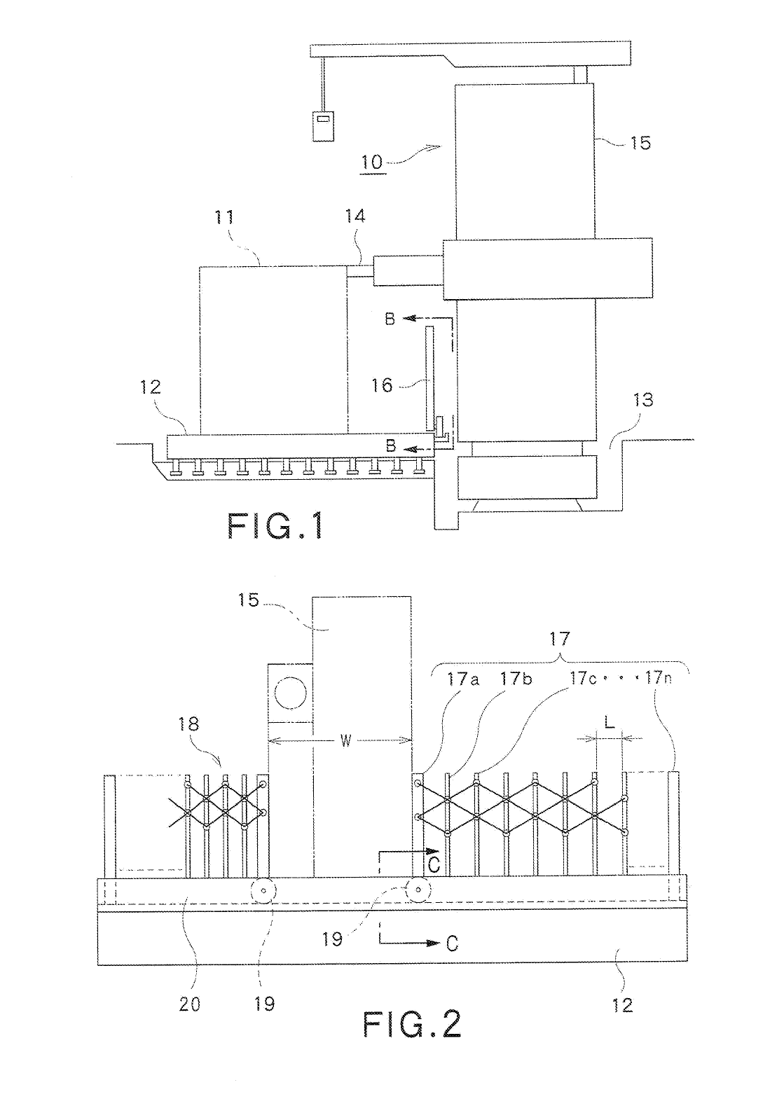

A suitable embodiment of a machine tool according to the present invention will be described in detail below, based on the accompanying drawings. FIG. 1 is a schematic view of a floor-type horizontal boring machine (floor-type machine tool for horizontal milling and boring) in one embodiment of the present invention.

The floor-type horizontal boring machine 10 shown in FIG. 1 is a large-size machine tool which an operator can enter. A deep groove 13 is disposed adjacently to a machine platen 12 on which a work 11 is placed as shown by an alternate long and two short dashes line (the groove 13 extends in a direction perpendicular to the sheet surface of FIG. 1). By moving a column 15 including a main spindle 14 with a working tool mounted thereon in the groove 13 along the direction of the groove 13, the work 11 placed on the machine platen 12 is processed.

A protective fence 16, which is the feature of the present invention, is provided on an edge part of the machine platen 12 on the side of the groove 13. As shown in FIG. 2, the protective fence 16 in this embodiment has a pantograph structure. Only a work processing range W (only a part opposed to the column 15) is opened, and the other range is provided as a protected area. The protected area is deformable (extendable and contractable) in accordance with the movement of the column 15.

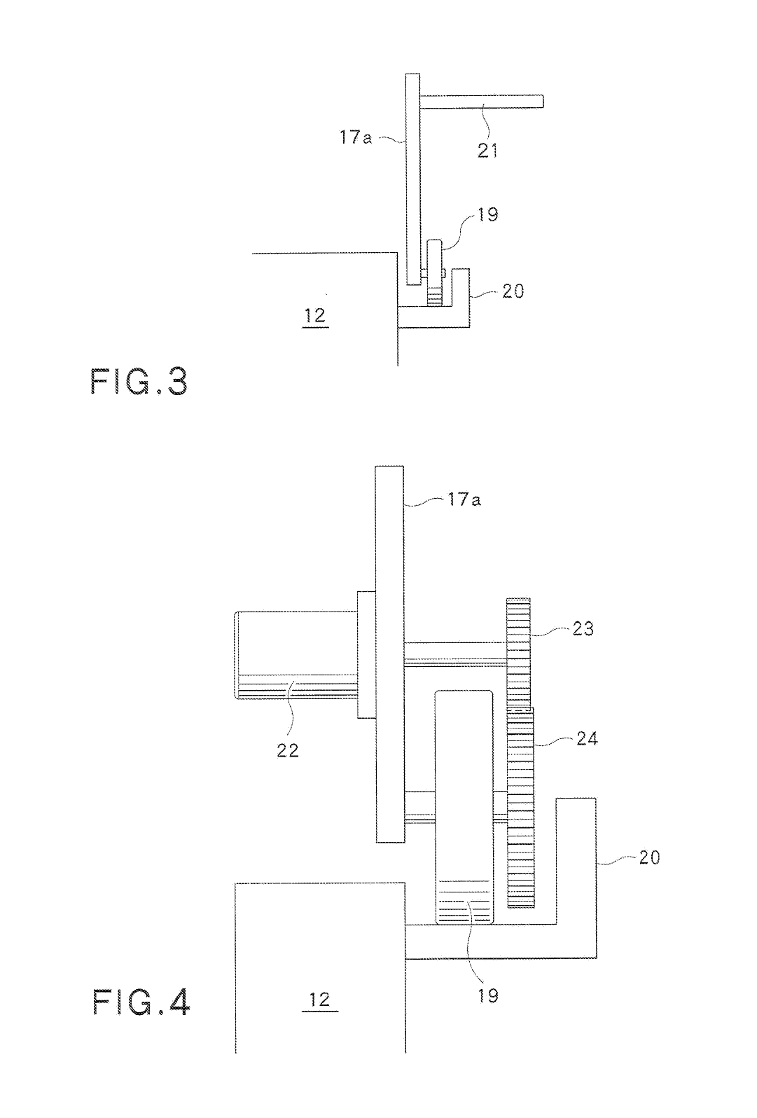

With reference also to FIGS. 2 and 3, the protective fence 16 is described in detail. The protective fence 16 of this embodiment is disposed on the edge part of the machine platen 12 along the groove 13, and is composed of a left (one side: right side in the drawings) protective fence 17 and a right (the other side: left side in the drawings) protective fence 18, with respect to the work processing range W. When one of the protective fences 17 and 18 is extended in accordance with the movement of the column 15, the other of the protective fences 17 and 18 is contracted, whereby only the work processing range W (only the part opposed to the column 15) is opened at all times.

Since the left protective fence 17 and the right protective fence 18 have substantially the same configuration, the left protective fence 17 is described in detail. As shown in FIG. 2, from the inside (from the side of the work processing range W), a plurality of poles 17a, 17b, 17c . . . 17n are connected to each other to define a pantograph structure. Only the last pole 17n is fixed, and the first (front) pole 17a is equipped with a wheel 19. As shown in FIG. 3, the machine platen 12 on the side of the groove 13 is provided with a guide 20 along the groove 13, and the wheel 19 is movable on the guide 20. A bracket 21 attached to a tool body such as the column 15 is connected to the first pole 17a, whereby the first pole 17a and the wheel 19 are moved together in accordance with the movement of the column 15.

Due to this structure, intervals L between the respective poles 17a, 17b, 17c . . . can be automatically changed in accordance with the movement of the column 15. Namely, the left protective fence 17 can be extended and contracted. Owing to this extension and contraction operation, the area protected by the left protective fence 17 can be set as a suitable area at all times, whereby the safety of the operator on the machine platen 12 can be more reliably ensured.

In the aforementioned embodiment, in order that the first pole 17a is moved synchronously with the movement of the column 15, the pole 17a is connected to the column 15 by the bracket 21. However, instead of employing such a connection, it is possible to employ a driving device dedicated for moving the protective fence.

For example, as shown in FIG. 4, a motor 22 as a driving device may be disposed on the first pole 17a, so that the wheel 19 is rotated via gears 23 and 24. In this case, the rotation of the motor 22 is preferably controlled so as to synchronize with the movement of the column 15.

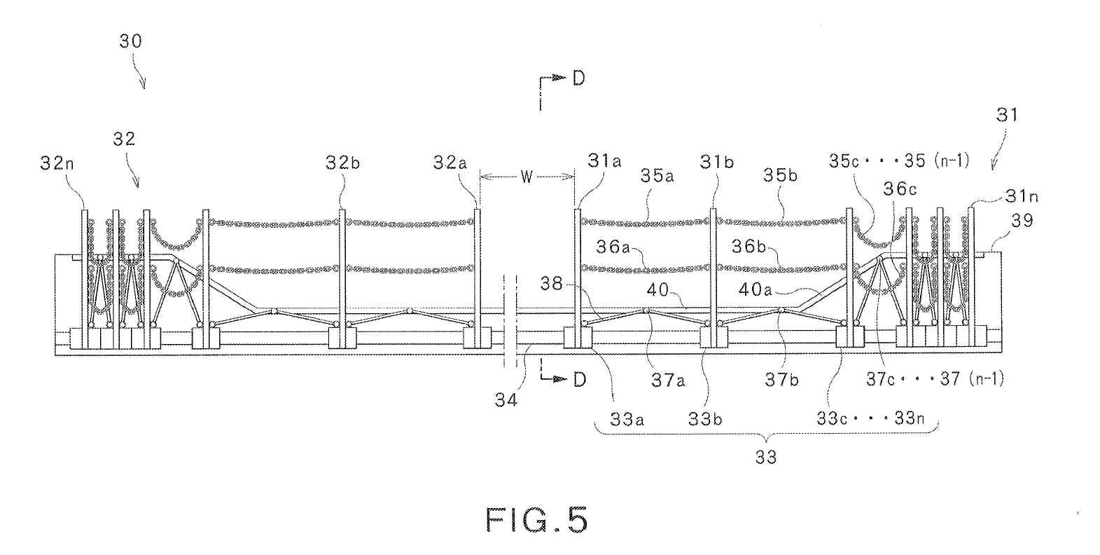

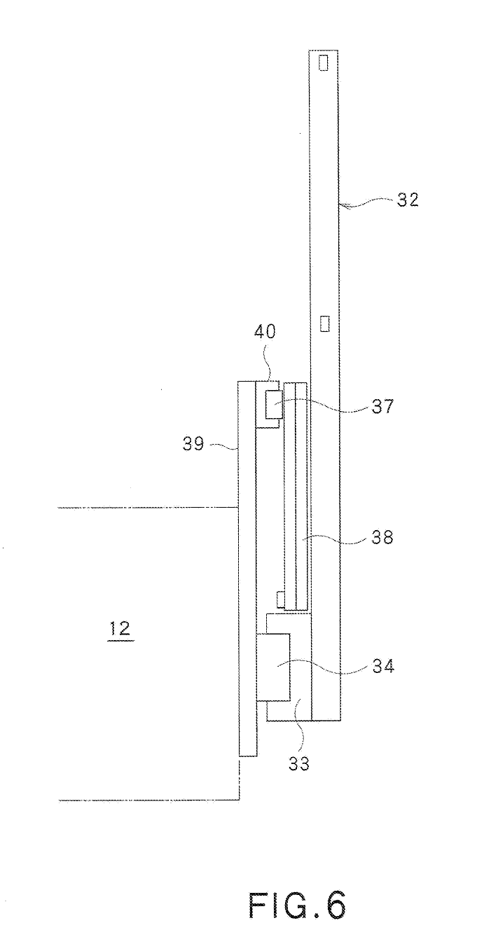

Next, with reference to FIGS. 5 and 6, another protective fence in which respective poles are connected to each other by chains is described. Similarly to the above protective fence 16, a protective fence 30 of this type is provided on the edge part of the machine platen 12 along the groove 13, and is composed of a left (one-side) protective fence 31 and a right (the other-side) protective fence 32, with respect to the work processing range W. When one of the protective fences 31 and 32 is extended in accordance with the movement of the column 15, the other of the protective fences 31 and 32 is contracted, whereby only the work processing range W (only the part opposed to the column 15) is opened at all times.

Since the left protective fence 31 and the right protective fence 32 have substantially the same configuration, the left protective fence 31 is described in detail. As shown in FIG. 5, from the inside (from the side of the work processing range W), a plurality of poles 31a, 31b . . . 31n are fixed on respective guide blocks 33 (33a, 33b, 33c . . . 33n). As shown in FIG. 6, disposed on the machine platen 12 on the side of the groove 13 is a guide rail 34 along the groove 13 via a bracket 39. The guide blocks 33 are movable along the guide rail 34. The plurality of poles 31a, 31b . . . 31n are connected to each other by chains 35a, 35b, 35c . . . 35(n−1) and chains 36a, 36b, 36c . . . 36(n−1). In addition, the plurality of poles 31a, 31b . . . 31n are connected to each other by links 38 (38a, 38b, 38c . . . 38(n−1)) having guide rollers 37a, 37b, 37c . . . 37(n−1), respectively.

When the column 15, which is not shown in FIG. 5, is moved so that intervals between the plurality of poles 31a, 31b . . . 31n are contracted, the guide blocks 33a, 33b, 33c . . . 33n are moved along the guide rail 34 disposed on the bracket 39, as well as the guide rollers 37a, 37b, 37c . . . 37(n−1) are moved in a link guide 40 disposed on the bracket 39. At this time, the respective chains 35, 36 sag, e.g., the chains 35c, 36c sag. In addition, as shown in FIG. 5, when the guide roller 37c moves into an inclined part 40a of the link guide 40, the guide roller 37 stands up to define a chevron shape.

The relationship between the first pole 31a and the column 15 may be the same as the relationship between the first pole 17a and the column 15, which is described with reference to FIGS. 2 to 4.

Due to the above structure, the intervals L between the respective poles 31a, 31b . . . are automatically changed in accordance with the movement of the column 15. Namely, the left protective fence 31 can be extended and contracted. Owing to this extension and contraction operation, the area protected by the left protective fence 31 can be set as a suitable area at all times, whereby the safety of the operator on the machine platen 12 can be more reliably ensured.

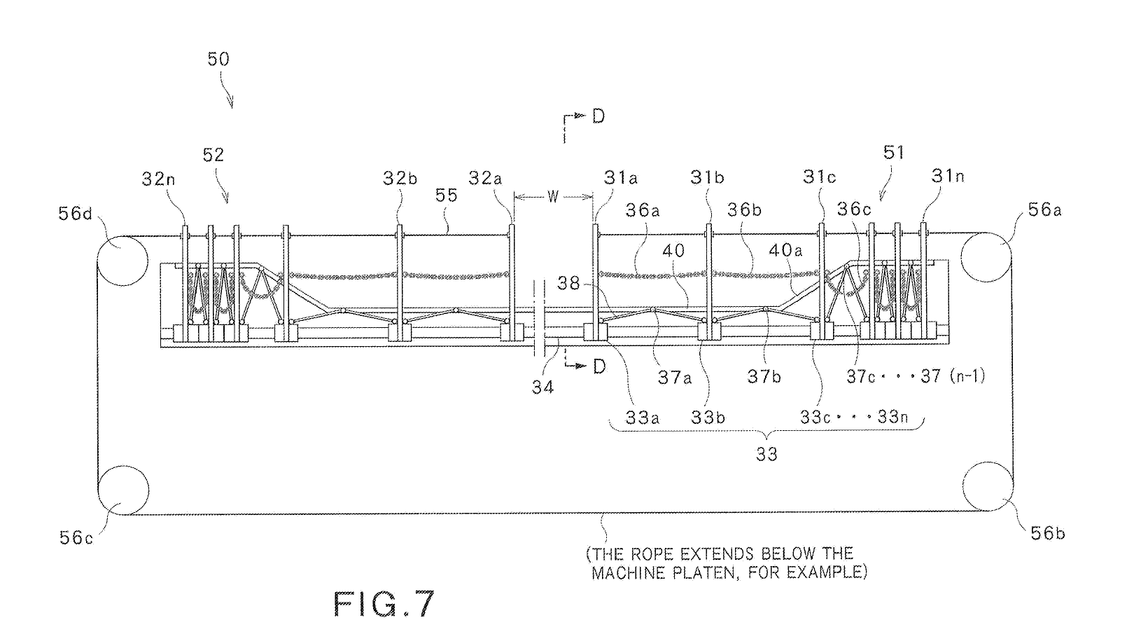

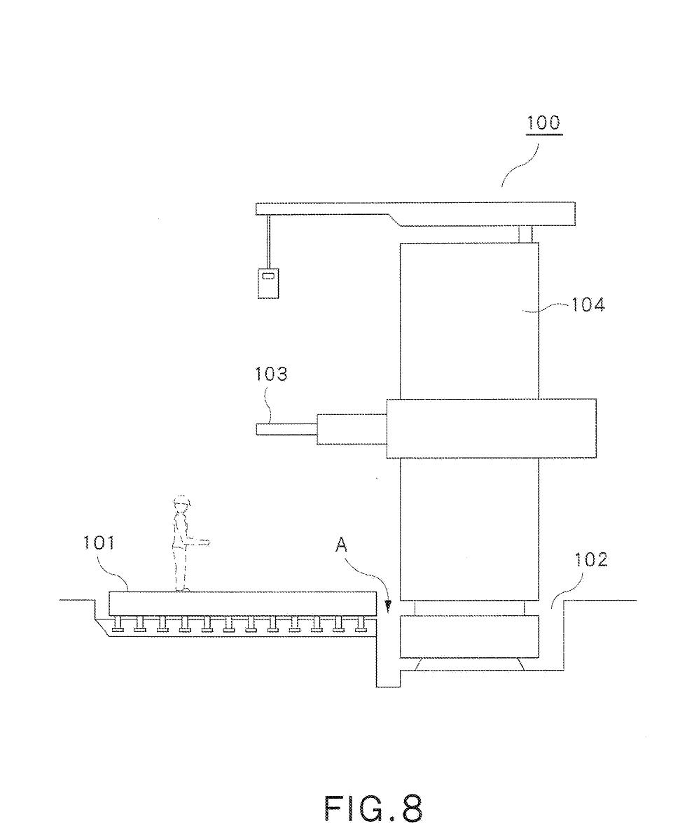

Next, with reference to FIG. 7, another protective fence, in which respective poles are connected to each other by a rope, is described. Similarly to the above protective fences 16 and 30, a protective fence 50 of this type is provided on the edge part of the machine platen 12 along the groove 13, and is composed of a left (one-side) protective fence 51 and a right (the other-side) protective fence 52, with respect to the work processing range W. When one of the protective fences 51 and 52 is extended in accordance with the movement of the column 15, the other of the protective fences 51 and 52 is contracted, whereby only the work processing range W (only the part opposed to the column 15) is opened at all times.

As shown in FIG. 7, in place of the chains 35a, 35b, 35c . . . 35(n−1), the protective fence 50 is equipped with one rope 55. More precisely, with one end of the one rope 55 being fixed on the first pole 31a of the left protective fence 51, the one rope 55 passes through respective through-holes provided in the second pole 31b, the third pole 31c . . . and the n-th pole 31n. The rope 55 further extends oppositely via an upper pulley 56a and a lower pulley 56b, which are located outside the last pole 31n. Then, via a lower pulley 56c and an upper pulley 56d, which are located outside the last pole 32n of the right protective fence 52, the rope 55 passes through respective through-holes provided in the n-th pole 32n . . . and the second pole 32b so as to reach the first pole 32a (the other end of the rope 55 is fixed on the first pole 32a of the right protective fence 52).

Since the other structures are the same as those of the protective fence 30 described with reference to FIGS. 5 and 6, the overlapping description is omitted.

Due to the above structure, even when intervals L between the respective poles 31a, 31b, 31c . . . and intervals between the respective poles 32a, 32b . . . are automatically changed in accordance with the movement of the column 15, the height of the rope 55 can be maintained constant at all times. Therefore, the safety of the operator on the machine platen 12 can be more reliably ensured.

In the above description, the floor-type boring machine is taken as an example of a large-size machine tool which an operator can enter. However, the application of the present invention is not limited thereto. For example, the present invention can be applied to another horizontal machining center having substantially the same configuration as that of the floor-type boring machine, or a machine tool of a gate-type, or a large-size machine tool of another type.

1. A machine tool in which a column including a main spindle with a working tool mounted thereon is movable in a direction along an edge part of a machine platen,
wherein a protective fence is provided on the edge part of the machine platen.

2. The machine tool according to claim 1,
wherein the protective fence includes:
one-side protective fence disposed on the column, on one side of the moving direction of the column; and
the other-side protective fence disposed on the column, on the other side of the moving direction of the column.

3. The machine tool according to claim 1, wherein
when the column is moved toward the one side of the moving direction, the one-side protective fence is configured to be contracted in the moving direction, and when the column is moved toward the other side of the moving direction, the one-side protective fence is configured to be extended in the moving direction, and
when the column is moved toward the one side of the moving direction, the other-side protective fence is configured to be extended in the moving direction, and when the column is moved toward the other side of the moving direction, the other-side protective fence is configured to be contracted in the moving direction.

4. The machine tool according to claim 1, wherein
the protective fence is configured to be moved or deformed in accordance with the movement of the column.

5. The machine tool according to claim 3, wherein
the protective fence is configured to be moved or deformed by a driving device for moving the column, in conjunction with the movement of the column.

6. The machine tool according to claim 3, wherein
the protective fence is configured to be moved or deformed by another driving device that is different from a driving device for moving the column.

7. The machine tool according to claim 1, wherein
the machine tool is a floor-type boring machine.

8. The machine tool according to claim 4, wherein
the protective fence is configured to be moved or deformed by a driving device for moving the column, in conjunction with the movement of the column.

9. The machine tool according to claim 4, wherein
the protective fence is configured to be moved or deformed by another driving device that is different from a driving device for moving the column.

10. The machine tool according to claim 2, wherein
the machine tool is a floor-type boring machine.

11. The machine tool according to claim 3, wherein
the machine tool is a floor-type boring machine.

12. The machine tool according to claim 4, wherein
the machine tool is a floor-type boring machine.

13. The machine tool according to claim 5, wherein
the machine tool is a floor-type boring machine.

14. The machine tool according to claim 6, wherein
the machine tool is a floor-type boring machine.
